(19) United States
(12) Patent Application Publication
(10) Pub. No.: US 2026/0189467 A1
(43) Pub. Date: Jul. 2, 2026

(54) Network Modeling Method, Network Problem Analysis Method, and Related Device

(71) Applicant: CLOUD INTELLEGENCE ASSETS HOLDING (SINGAPORE) PRIVATE LIMITED, Singapore (SG)

(72) Inventors: Biao LYU, Hangzhou, Zhejiang (CN); Junkai NIU, Hongzhou, Zhejiang (CN); Shunmin ZHU, Hongzhou, Zhejiang (CN); Xiong XIAO, Hongzhou, Zhejiang (CN); Shuai YANG, Hongzhou, Zhejiang (CN); Yong PAN, Hongzhou, Zhejiang (CN); Tengchang RUI, Hongzhou, Zhejiang (CN); Zeyun HAN, Hongzhou, Zhejiang (CN); Yangyang SHI, Hongzhou, Zhejiang (CN)

(21) Appl. No.: 19/130,449

(22) PCT Filed: Nov. 15, 2023
(86) PCT No.: PCT/CN2023/131850

§ 371 Date: May 15, 2025

(30) Foreign Application Priority Data
Nov. 15, 2022 (CN) 202211426787.9

(51) Int. Cl. H04L 41/14; H04L 41/122

(52) U.S. Cl. CPC H04L 41/145; H04L 41/122

(57) ABSTRACT

Embodiments of the present disclosure provide a network modeling method, a network problem analysis method, and a related device, and the network modeling method includes that: multi-dimensional instance information of various resources in a virtual network is collected, where the multi-dimensional instance information of the resources includes an instance identifier of each resource and at least one entity attribute of each resource, and the at least one entity attribute is an instance attribute other than the instance identifier in the multi-dimensional instance information; each resource is abstracted into a node based on the instance identifier of each resource; and, within the nodes abstracted from the resources, entities are abstracted based on the at least one entity attribute of each resource; and relationships between different nodes are determined based on relationships between associated entities.

The present disclosure claims priority of Chinese Patent Application No. 202211426787.9, filed to China National Intellectual Property Administration on Nov. 15, 2022 and titled “Network Modeling Method, Network Problem Analysis Method, and Related Device”, the content of which is hereby incorporated by reference in its entirety.

### TECHNICAL FIELD

Embodiments of the present disclosure relates to the field of network technology, and in particular to a network modeling method, a network problem analysis method, and a related device.

### BACKGROUND OF THE INVENTION

With the development of cloud computing and virtualization technology, a virtual network, such as an Overlay network, is deployed in a cloud network to achieve the virtualization of network resources. The virtual network, such as the Overlay network, is regarded as being superimposed on the basis of a physical network, used for realizing the virtualization of network resources.

As the cloud network operates, the virtual network may encounter network problems, at which point it becomes necessary to analyze the impact surface of the network problems to determine the influence scope of the network problems. During the analysis of the impact surface of the network problems, the analysis of resource correlation relationships is involved. Thus, how to establish a standardized and accurate network model of the virtual network, so as to reflect the topological relationship of resources in the virtual network, has become an urgent technical problem which has not been solved by a person having ordinary skill in the art.

### SUMMARY OF THE INVENTION

In view of this, embodiments of the present disclosure provide a network modeling method, a network problem analysis method, and a related device. Abstract modeling is performed on a virtual network through multi-dimensional resource data of the virtual network, thereby establishing a standardized and accurate network model of the virtual network, enhancing the standardization level and accuracy of the network model of the virtual network. Based on the network model of the virtual network, impact surface analysis is performed on network problems, thereby improving the comprehensiveness and accuracy of an analysis result of the impact surface.

To solve the aforementioned problem, the embodiments of the present disclosure provide the following technical solutions.

In the first aspect, the embodiments of the present disclosure provide a network modeling method, which includes that: multi-dimensional instance information of various resources in a virtual network is collected, where the multi-dimensional instance information of the resources includes an instance identifier of each resource and at least one entity attribute of each resource, and the at least one entity attribute is an instance attribute other than the instance identifier in the multi-dimensional instance information; each resource is abstracted into a node based on the instance identifier of each resource; and, within the nodes abstracted from the resources, entities are abstracted based on the at least one entity attribute of each resource, where one entity attribute of each resource is abstracted into one entity in a node of each resource; and relationships between different nodes are determined based on relationships between associated entities, where the abstracted nodes, entities in the abstracted nodes, and relationships between the abstracted nodes collectively form at least one basic network model of the virtual network.

In the second aspect, the embodiments of the present disclosure provide a network problem analysis method, which includes that: network problem prediction is performed on a target resource in a virtual network; in response to predicting a network problem with the target resource, based on a network model of the virtual network, associated resources related to the target resource in the virtual network are determined, where the network model of the virtual network is constructed based on the network modeling method as mentioned in the first aspect; network problem prediction is performed on the associated resources; in response to predicting a network problem with the associated resources, it is determined that the associated resources are in the impact scope of the network problem of the target resource.

In the third aspect, the embodiments of the present disclosure provide a cloud server, including: a modeling platform, arranged for executing the network modeling method as mentioned in the first aspect; a data management platform, arranged for combining time-series data and multi-dimensional instance information of a target resource in a virtual network to obtain the time-series data of the target resource carrying the multi-dimensional instance information; and combining time-series data and multi-dimensional instance information of associated resources in the virtual network to obtain the time-series data of the associated resources carrying the multi-dimensional instance information; a data analysis engine, arranged for predicting time-series change of the target resource based on the time-series data of the target resource carrying the multi-dimensional instance information, in response to an anomaly being in the time-series change of the target resource, determining the associated resources having a topological association with the target resource based on the network model constructed by the modeling platform and predicting time-series change of the associated resources based on the time-series data of the associated resources carrying the multi-dimensional instance information, and in response to an anomaly being in the time-series change of the associated resources, determining that the associated resources are in the impact scope of time-series change anomaly of the target resource.

In the fourth aspect, the embodiments of the present disclosure provide a cloud server, including: at least one memory and at least one processor, where the at least one memory stores at least one computer-executable instruction, and the at least one processor calls the at least one computer-executable instruction to execute the network modeling method as mentioned in the first aspect, or the network problem analysis method as mentioned in the second aspect.

In the fifth aspect, the embodiments of the present disclosure provide a storage medium, where the storage medium stores at least one computer-executable instruction, and the at least one computer-executable instruction is executed to implement the network modeling method as mentioned in the first aspect, or the network problem analysis method as mentioned in the second aspect.

In the sixth aspect, the embodiments of the present disclosure provide a computer program, and the computer program is executed to implement the network modeling method as mentioned in the first aspect, or the network problem analysis method as mentioned in the second aspect.

### BRIEF DESCRIPTION OF DRAWINGS

In order to more clearly illustrate technical solutions in embodiments of the present disclosure or related art, drawings required for the description of the embodiments or related art will be briefly introduced below. Obviously, the drawings mentioned in the following description are examples of the present disclosure. For a person having ordinary skill in the art, other drawings can also be obtained based on these drawings without engaging in creative efforts.

FIG. 1 is an exemplary diagram of a cloud network architecture.

FIG. 2 is an exemplary diagram of a virtual network architecture.

FIG. 3 is a flowchart of a network modeling method according to some embodiments of the present disclosure.

FIG. 4 is an exemplary diagram of virtual resources based on the virtualization of physical resources.

FIG. 5A is an exemplary diagram of an abstract node and entities in an abstract node.

FIG. 5B is an exemplary diagram of relationships between nodes.

FIG. 6A is a flowchart of another network modeling method according to some embodiments of the present disclosure.

FIG. 6B is a flowchart of another network modeling method according to some embodiments of the present disclosure.

FIG. 7 is an exemplary diagram of a network model of a virtual network according to some embodiments of the present disclosure.

FIG. 8A is a flowchart of a network problem analysis method according to some embodiments of the present disclosure.

FIG. 8B is a flowchart of another network problem analysis method according to some embodiments of the present disclosure.

FIG. 9 is an exemplary diagram of a system architecture according to some embodiments of the present disclosure.

FIG. 10 is a block diagram of a network modeling apparatus according to some embodiments of the present disclosure.

FIG. 11 is a block diagram of a network problem analysis apparatus according to some embodiments of the present disclosure.

FIG. 12 is a block diagram of a cloud server according to some embodiments of the present disclosure.

### DETAILED DESCRIPTION OF THE INVENTION

The present disclosure will be described in further detail with reference to drawings of embodiments of the present disclosure, providing a clear and complete description of technical solutions according to embodiments of the present disclosure. It is apparent that the described embodiments are some rather than all embodiments of the present disclosure. Based on the embodiments of the present disclosure, all other embodiments obtained by a person having ordinary skill in the art without making any inventive effort fall within the scope of protection of the present disclosure.

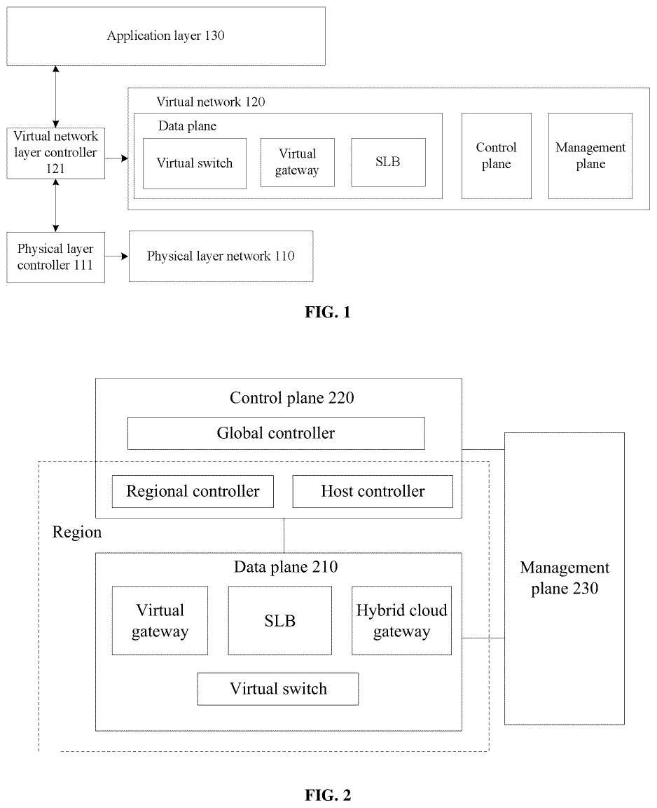

For better understanding of a cloud network, FIG. 1 exemplarily shows an architectural diagram of the cloud network. As shown in FIG. 1, the cloud network mainly consists of three layers, including: a physical layer network 110 and a physical layer controller 111 at the bottom layer, a virtual network 120 and a virtual network layer controller 121 based on the physical layer network 110, and an application layer 130.

The physical layer network 110 is a physical network based on Software Defined Network (SDN), such as, an SDN-based Underlay network, which is composed of various physical devices to ensure Internet Protocol (IP) connectivity between devices through a routing protocol. The physical layer controller 111 is arranged for managing the physical layer network 110 and providing an Application Programming Interface (API) to the virtual network 120 while shielding various details of the physical layer network 110. The physical layer controller 111 can be, for example, an Underlay SDN Controller.

The virtual network 120 is an Overlay network based on the physical layer network 110, arranged for virtualizing network resources based on the physical layer network 110. The virtual network 120 includes a data plane, a control plane and a management plane, etc. The data plane includes a virtual gateway, a virtual switch, a Server Load Balance (SLB), and other network components. The virtual network layer controller 121 is arranged for managing various network components of the virtual network 120 and providing a unified API to applications and services at the application layer 130. The virtual network layer controller 121 invokes the physical layer controller 111 at the bottom layer to fulfill network functions. The virtual network layer controller 121 can be, for example, an Overlay Controller.

The application layer 130 includes various application products and services of the cloud network. The various application products and services realize the use and scheduling of the cloud network through invoking an interface of the virtual network layer controller 121.

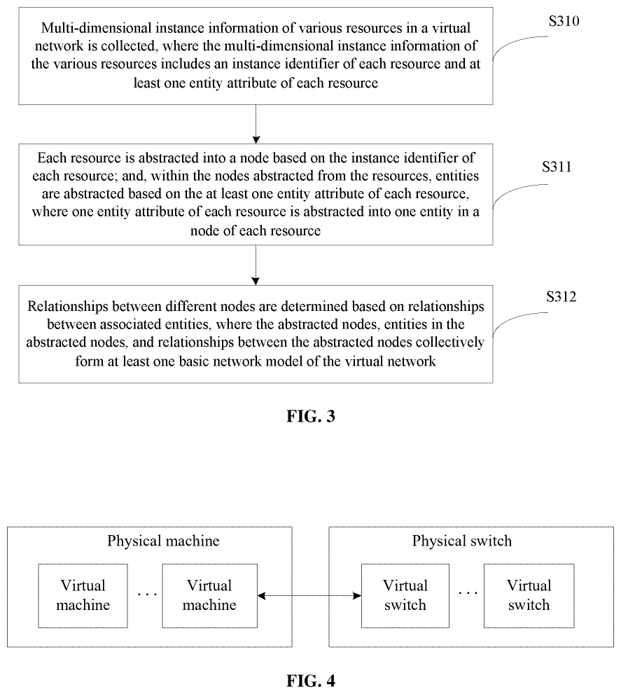

For better understanding of the virtual network in the cloud network, FIG. 2 exemplarily shows an architectural diagram of a virtual network. As shown in FIG. 2, the virtual network (e.g., Overlay network) mainly includes three planes: a data plane 210, a control plane 220, and a management plane 230.

The data plane 210 of the virtual network primarily includes various network components such as a virtual gateway, a SLB, a hybrid cloud gateway, a virtual switch, etc. To improve forwarding performance of these network components, acceleration technologies such as user-space protocol stack technology can be introduced. The control plane 220 of the virtual network consists of a hierarchical controller system aimed at ensuring scalability of the control plane. This controller system includes a host controller arranged on each physical machine, a region controller arranged in each region, and a global controller. The host controller acquires a configuration plan for various network components of the data plane from the region controller and manages and schedules network resources on the physical machine. The region controller manages and schedules network resources in the region. The global controller coordinates and schedules network resources across regions, particularly managing and scheduling global traffic. The management plane 230 of the virtual network is considered as a separate entity responsible for collecting data from logs, databases, etc., of the other two planes (data plane 210 and control plane 220) of the virtual network to facilitate on-site recovery and anomaly debugging. The management plane 230 further provides automated network management through analysis and learning of data.

Numerous resources exist in the virtual network, primarily divided into virtual resources and physical resources. The virtual resources are obtained through virtualization of the physical resources. Resources in the virtual network can be categorized into virtual network resources, physical network resources, cloud network elements, and physical forwarding devices, etc.

Virtual network resources are regarded as a type of the virtual resource, the virtual network resources are network resources virtualized based on physical network resources, and the virtual network resources are entities of resources provided for users to utilize cloud computing functionalities, such as virtual machines virtualized based on physical machines. The physical network resources are considered as a type of the physical resource, serving as the foundation for the virtual network resources, used for virtualizing the virtual network resources, e.g., the physical machines used for the virtualizing virtual machines. The cloud network elements are considered as a type of the virtual resource, and the cloud network elements are virtual physical forwarding devices virtualized based on the physical forwarding devices, such as virtual switches, virtual gateways, etc., available for use by users of the cloud network. The physical forwarding devices are considered as a type of the physical resource. The physical forwarding devices form the basis for the cloud network elements, and the physical forwarding devices are used for virtualizing the cloud network elements, e.g., the physical forwarding devices are the physical switches used for virtualizing the virtual switches, or the physical forwarding devices are the physical gateways used for virtualizing the virtual gateways, etc.

Various network components contained in the data plane 210 of the virtual network are considered as the virtual resources virtualized based on the physical resources (e.g., the physical network resources, the physical forwarding devices), related to the virtual network resources, the cloud network elements, and other virtual resources mentioned above.

During the operation of the cloud network, resources in the virtual network may encounter the network problem, which could be abnormalities in the virtual resources, abnormalities in the physical resources used by the virtual resources, and other network-related problems, for example, at least one virtual machine is abnormal, at least one physical machine is abnormal, etc. When the network problem occurs in the virtual network (e.g., an Overlay network), it is necessary to analyze the impact scope of the network problem. That is, the impact extent of the network problem in the virtual network is analyzed. For instance, when an anomaly occurs on one physical machine, it is necessary to analyze and determine multiple virtual machines affected by this physical machine.

When analyzing the impact scope of the network problem, the correlation of a network topology is analyzed to analyze the impact scope of the network problem. For example, when the network problem occurs in the physical network, a physical device topology of the physical network is analyzed to determine the physical devices affected by the physical network under the network problem. However, in scenarios related to an Overlay network and other types of virtual networks, a network topology of the Overlay network and other virtual networks is different from that a network topology of the physical network, and the impact scope of the network problem cannot be analyzed through fixed topological relationships of physical devices. That is, the topological relationships between the physical devices in the physical network is relatively fixed, whereas the Overlay network and other virtual networks relate to the virtual resources, thus association between the virtual network resources, the physical network resources, the cloud network elements, the physical forwarding devices, and other resources in the virtual network dynamically changes. In scenarios related to the Overlay network and other virtual networks, it is not feasible to use similar fixed topological relationships of the physical devices to analyze the impact scope of the network problem. Specifically, the network topology of the physical network is relatively fixed (for example, the topological relationship between the physical devices in the physical network is relatively stable). However, after abstracting the physical devices into the virtual resources in the Overlay network and other virtual networks, the topological relationship between the virtual resources changes compared with the topological relationship between the physical devices, along with modifications to the virtual resources, thereby leading to dynamic changes in associations between the resources in the virtual network, making it difficult to analyze the impact scope of the network problem in the virtual network using fixed topological relationships of the physical devices.

Based on this, for the Overlay network and other virtual networks, how to provide a standardized and accurate modeling solution to establish a highly standardized and accurate network model for subsequent precise analysis of the impact scope of the network problem in the virtual network becomes particularly crucial. It should be noted that the highly standardized and highly accurate network model established for the virtual network according to the embodiments of the present disclosure can further be applied to other task scenarios of the virtual network and is not limited to scenarios for analyzing the impact scope of the network problem.

The network modeling method provided by the embodiments of the present disclosure can utilize, based on multi-dimensional resource data of the Overlay network and other virtual networks, a modeling platform to perform abstract modeling on the virtual network, so at least to construct the basic network model of the virtual network. In some embodiments, the multi-dimensional resource data includes the multi-dimensional instance information of each resource. The multi-dimensional instance information of each resource includes multiple instance attributes of each resource. For each resource, the embodiments of the present disclosure can abstract each resource as a node based on the instance identifier in the instance information of each resource, and abstract other instance attributes in the instance information of each resource as the entities in the node, thereby performing abstract representation on the resources and the instance attributes of the resources in the virtual network. Subsequently, the embodiments of the present disclosure can reflect the relationships between the abstracted nodes by means of the relationships between the entities in the nodes among different nodes, enabling different nodes in the abstract representation to have relational expression, achieving the construction of the basic network model. As such, through the basic network model, the embodiments of the present disclosure can reflect the resources in the virtual network, the instance attributes of the resources, and the attribute relationships between different resources, thereby comprehensively and accurately reflecting the inter-resource association in the virtual network, capable of establishing the network model for the virtual network with changing resource relationships, enhancing the standardization level and accuracy of the network model for the virtual network.

Based on the basic network model, the embodiments of the present disclosure can construct a domain model and a business model. The domain model contains different domain fields (different domain fields can represent different resource events), thus combining the domain fields in the domain model with the nodes and the entities in the nodes in the basic network model enables the nodes and the entities in the basic network to be associated with different resource events, further enhancing the comprehensiveness and accuracy of the network model for the virtual network. The business model contains different business fields (for example, different business fields can reflect business attributes of resources, such as instance businesses, etc.), hence combining the business fields in the business model with the nodes and the entities in the nodes in the basic network model enables the nodes and the entities in the basic network to be associated with different businesses, further enhancing the comprehensiveness and accuracy of the network model for the virtual network. In some embodiments, the basic network model is combined with both the domain model and the business model, rather than being limited to combining the basic network model with either the domain model or the business model alone.

In some embodiments, FIG. 3 exemplarily shows a flowchart of a network modeling method according to some embodiments of the present disclosure. The method is executed and realized by a modeling platform. The modeling platform is deployed on a cloud server side, for example, in a cloud server where a function part for establishing models is implemented. The cloud server is considered as a server cluster providing cloud services such as cloud computing, and the cloud server provide the cloud services such as the cloud computing to users through a cloud network. As shown in FIG. 3, the method includes the following steps.

In step S310, multi-dimensional instance information of various resources in a virtual network is collected, where the multi-dimensional instance information of the resources includes an instance identifier of each resource and at least one entity attribute of each resource.

In some embodiments, the multi-dimensional instance information of each resource in the virtual network is regarded as instance information of each resource in multiple dimensions in the virtual network. That is, resource data of the resources is instance information of the resources and the resource data has multiple different dimensions. The embodiments of the present disclosure can achieve collecting the multi-dimensional instance information of the resources in the virtual network through collecting the multi-dimensional instance information of the resources in the virtual network.

In some embodiments, the multi-dimensional instance information of the resources includes the instance attributes of the resources in the multiple dimensions. The instance attributes of the resources in the multiple dimensions are divided into an instance identifier of each resource (such as an instance ID), and other instance attributes besides the instance identifier. When constructing the basic network model for the virtual network, for any resource in the virtual network, the nodes in the basic network model are abstracted based on the instance identifier of each resource. There is at least one or entity in each node, and the at least one or entity in the node is abstracted based on other instance attributes of the resources except the instance identifier. Thus, other instance attributes of the resources except the instance identifier are referred to as entity attributes used for abstracting the entities.

That is, for ease of explanation in the present disclosure, other instance attributes of the multiple instance attributes of the resources except the instance identifier is referred as the entity attributes (used for abstracting the entities in the nodes). For example, other instance attributes such as an instance model, an instance region (the instance region reflects the region where resources is located) etc. of the multiple instance attributes of the resources except the instance identifier are called the entity attributes. For each resource, each resource has a unique instance identifier and at least one entity attribute besides the instance identifier.

In some embodiments, the embodiments of the present disclosure collect the multi-dimensional instance information of the various virtual resources (such as various virtual network resources, and various cloud network elements, etc.) in the virtual network, and the multi-dimensional instance information of the various physical resources (such as various physical network resources, and various physical forwarding devices, etc.) to achieve collecting multi-dimensional instance information of each resource in the virtual network. In some examples, the embodiments of the present disclosure can achieve collecting the multi-dimensional instance information of the various virtual resources and the various physical resources in the virtual network through collecting the multi-dimensional instance information (for instance, various instance attributes of the resources in different dimensions such as the instance identifier, the instance model, the instance region, etc.) of the resources in the Overlay network including the various virtual network resources, the various physical network resources, the various cloud network elements, and the various physical forwarding devices.

In some embodiments, since the physical resources contain specific physical entities (e.g., physical machines, physical switches, etc.), the embodiments of the present disclosure can collect multi-dimensional instance information of physical entities of the various physical resources. For example, the embodiments of the present disclosure can collect multi-dimensional instance information of physical entities of the physical machines (one example of the physical network resources), or collect multi-dimensional instance information of physical entities of the physical switches (one example of physical forwarding devices). In some embodiments, since the virtual resources in the virtual network are derived through performing virtualization on the physical resources and the virtual resources serve as network components in the virtual network, the embodiments of the present disclosure collect multi-dimensional instance information of the network components of the various virtual resources. For example, the embodiments of the present disclosure collect multi-dimensional instance information of network components of the virtual machines (one example of the virtual network resources), or collect multi-dimensional instance information of network components of the virtual switches (one example of the cloud network elements).

For ease of understanding, taking the physical resources as the physical machines and the physical switches, and the virtual resources as the virtual machines and the virtual switches, FIG. 4 exemplarily shows a schematic diagram of virtual resources based on the virtualization of physical resources. As shown in FIG. 4, the physical machines virtualize into multiple virtual machines through virtualization technology. The virtual machines derived from virtualization serve as the network components in the virtual network, provided to users (e.g., rented to users) so that the users can run application products or services through the virtual machines. The physical switches virtualize into multiple virtual switches through virtualization technology, and the virtual switches are arranged for enabling communication among the virtual machines. It should be noted that the cloud network contains the multiple physical machines and the multiple physical switches. Each physical machine virtualizes into the multiple virtual machines, and each physical switch virtualizes into the multiple virtual switches. Based on the example of FIG. 4, the embodiments of the present disclosure separately collect multi-dimensional instance information of each physical machine, separately collect multi-dimensional instance information of each virtual machine, separately collect multi-dimensional instance information of each physical switch, and separately collect multi-dimensional instance information of each virtual switch.

In some embodiments, the embodiments of the present disclosure collect multi-dimensional instance information of the resources from a database. For example, the multi-dimensional instance information of the various physical resources and the various virtual resources is collected from a database, thereby supporting collecting the multi-dimensional instance information of the resources in the virtual network from multiple types of databases, so as to construct the network model for the virtual network.

The multi-dimensional instance information of the resources collected by the embodiments of the present disclosure originates from different devices (e.g., multi-dimensional instance information of the physical machines originates from the physical machines, multi-dimensional instance information of the physical switches originates from the physical switches), and the instance attributes contained in the instance information from different sources or different dimensions vary (e.g., the instance attributes contained in the instance information of virtual machines differ from the instance attributes contained in the instance information of the physical machines, the instance attributes contained in the instance information of the virtual machines differ from the instance attributes contained in the instance information of the virtual switches). Therefore, the multi-dimensional instance information of the resources collected by the embodiments of the present disclosure can be in a form of multi-source heterogeneous.

In step S311, each resource is abstracted into a node based on the instance identifier of each resource; and, within the nodes abstracted from the resources, entities are abstracted based on the at least one entity attribute of each resource, where one entity attribute of each resource is abstracted into one entity in a node of each resource.

The embodiments of the present disclosure at least construct the basic network model for the virtual network when constructing the network model for the virtual network. The basic network model is formed at least by the abstracted nodes, the entities in the abstracted nodes, and relationships between the abstracted nodes. After obtaining the instance information of each resource in the virtual network, for any resource, the embodiments of the present disclosure abstract each resource into a node in the basic network model based on the instance identifier of each resource. Based on the entity attributes of each resource, the entities are abstracted from the node, which is abstracted from each resource (one entity attribute of each resource is abstracted into one entity in the node of each resource), to achieve constructing the nodes and the entities in the nodes in the basic network.

In some embodiments, the instance identifier of each resource is considered as a unique identifier of each resource in the virtual network. Therefore, after obtaining the instance information of each resource, the embodiments of the present disclosure abstract each resource into a node based on the instance identifier in the instance information of each resource, thereby enabling different nodes in the basic network model to be distinguished by different instance identifiers. In some embodiments, after collecting the multi-dimensional instance information of the resources in the virtual network, the embodiments of the present disclosure abstract each resource into a node respectively, and extract the instance identifier of each resource as metadata, which is stored in the node of each resource, to achieve abstracting each resource into the node based on the instance identifier of each resource (the abstracted node is identified by the instance identifier of the corresponding resource). In some examples, the instance identifier of each resource is an instance ID of each resource, such as an instance ID of each physical resource (e.g., an ID of each physical machine, an ID of each physical switch, etc.), and an instance ID of each virtual resource (e.g., an ID of each virtual machine, an ID of each virtual switch, etc.).

It is understandable that the multi-dimensional instance information of the resources in the virtual network, as the multi-dimensional resource data of the virtual network, is in a multi-source form. The embodiments of the present disclosure achieve abstracting each resource in the virtual network into a node based on the instance identifier of each resource. Since the instance identifier of each resource uniquely identifies each resource in the virtual network, even if the instance information of different resources comes from different sources, the embodiments of the present disclosure can uniformly distinguish the instance information of different resources through the instance identifier of each resource without considering the impact of multi-source on the instance information of different resources. That is, through uniformly extracting the instance identifier of each resource and abstracting each resource into a node, the embodiments of the present disclosure enable resources with different sources of instance information to be distinguished by the instance identifier of each resource.

After constructing the nodes in the basic network, the embodiments of the present disclosure can further abstract the entities in the nodes to reflect other instance attributes of the resources besides the instance identifier (i.e., entity attribute). In some embodiments, for any resource, the embodiments of the present disclosure abstract one entity attribute of each resource into one entity in the node abstracted from this resource, to achieve abstracting entities based on the entity attribute of this resource in the node abstracted from this resource. In some examples, taking an instance model and an instance region of each resource as an example (the instance model and the instance region being examples of the entity attributes), the embodiments of the present disclosure can abstract the instance model of each resource into an entity and the instance region of each resource into an entity in the node abstracted from each resource.

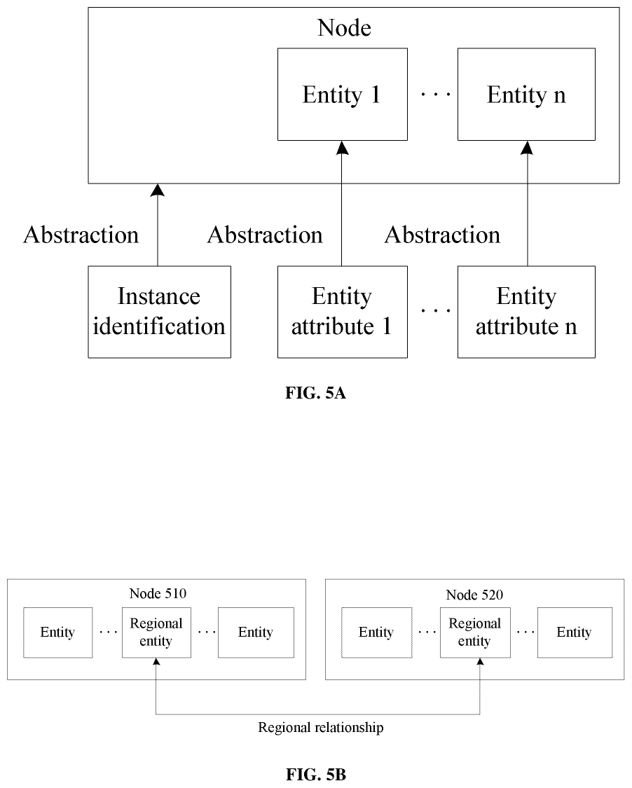

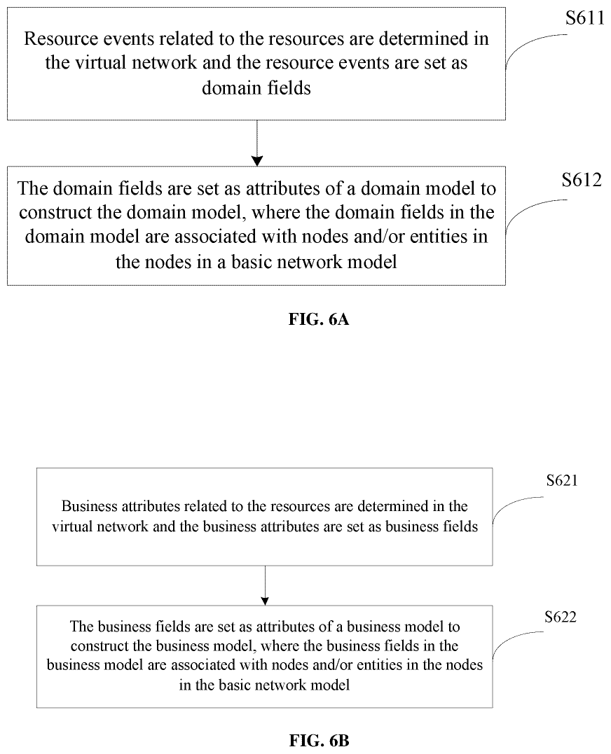

For ease of understanding, as one example, FIG. 5A illustratively shows a diagram of abstract nodes and entities in the nodes. As shown in FIG. 5A, it is assumed that for each resource, the instance information of each resource contains the instance identifier and n entity attributes (entity attributes 1 to n), the embodiments of the present disclosure abstract various resources into nodes and store the instance identifier of each resource as metadata in each node. Simultaneously, the entity attributes 1 to n of each resource are respectively abstracted into the entities in the nodes, thereby abstracting n entities (entity 1 to n) in the nodes. An entity Attribute 1 corresponds to an abstracted Entity 1, and so on, an entity Attribute n corresponds to an abstracted entity n. It should be noted that multiple entities located in the same node are considered to have no association relationship.

It can be understood that the multi-dimensional instance information of the resources in the virtual network serves as the multi-dimensional resource data of the virtual network, which may be in a heterogeneous form. After the embodiments of the present disclosure abstract the resources in the virtual network into the nodes, the entities in the nodes are abstracted based on the instance attributes of each resource other than the instance identifier. Therefore, even if the instance information of different resources is heterogeneous, the specific types of the abstracted entities in each node of each resource are affected, and a process of abstracting the entities based on specific attribute content in each node does not affected.

In step S312, relationships between different nodes are determined based on relationships between associated entities, where the abstracted nodes, entities in the abstracted nodes, and relationships between the abstracted nodes collectively form at least one basic network model of the virtual network.

After abstracting the nodes for the resources and abstracting the entities in the nodes of the resources, the embodiments of the present disclosure determine relationships between the abstracted nodes, thereby at least forming the basic network model of the virtual network through the abstracted nodes, the entities in the abstracted nodes, and relationships between the abstracted nodes. In some embodiments, relationships between different nodes can be determined by relationships between the associated entities in different nodes. The associated entities in different nodes are the entities of the same type in different nodes. For instance, the entities abstracted based on the same type of the entity attributes in different nodes (such as the entities abstracted based on regional instances in different nodes). In other embodiments, the associated entities in different nodes are different types of the entities specified to have an association relationship in different nodes (the types of the entities having the association relationship can be predetermined, and the embodiments of the present disclosure do not limit this). The entities of the same type are abstracted based on the same type of the entity attributes, and the entities of different types are abstracted based on different types of the entity attributes. It should be noted that, the embodiments of the present disclosure can determine relationships between the abstracted nodes through identifying relationships between the associated entities in different nodes at the node level. For example, when different nodes are associated through at least one associated entity, the relationships between different nodes can be determined at the node level through relationships between the at least one associated entity.

For ease of understanding, FIG. 5B illustratively shows an example diagram of relationships between nodes. As shown in FIG. 5B, it is assumed that there are a node 510 and a node 520, both the node 510 and the node 520 abstract multiple entities and the multiple entities contain a regional entity. The regional entity in the node 510 is abstracted based on an instance region of resources in the node 510, and the regional entity in the node 520 is abstracted based on an instance region of resources in the node 520. The regional entity in the node 510 and the regional entity in the node 520 are regarded as the associated entities between the node 510 and the node 520. When the embodiments of the present disclosure determine relationships between the node 510 and the node 520, one relationship between the node 510 and the node 520 is a regional relationship between the regional entity of the node 510 and the regional entity of the node 520. It is assumed that the instance region of resources in the node 510 contains the instance region of resources in the node 520 (for example, the region corresponding to resources in the node 510 is a higher-level region than the region corresponding to resources in the node 520), and one relationship between the node 510 and the node 520 includes that a region of the node 510 contains a region of the node 520. It should be noted that illustrative content of FIG. 5B is for ease of understanding that relationships between different nodes are determined based on relationships between the associated entities in different nodes, and there are multiple pairs of associated entities in different nodes, with each pair of associated entities possibly having one relationship, thus relationships between different nodes include relationships between the multiple pairs of associated entities (i.e., multiple relationships), rather than being limited to one single relationship.

In some embodiments, steps S311 and S312 can be executed and realized by modeling personnel using a modeling platform. For example, the modeling personnel use the modeling platform to abstract each resource into the node based on expert experience, and extract the instance ID of each resource as metadata stored in each node of each resource. Simultaneously, the modeling personnel use the modeling platform to abstract an instance name, an instance region, and other instance attributes of each resource except the instance ID into the entities in the nodes based on expert experience. Simultaneously, the relationships between associated entities in different nodes are set as the relationships between different nodes (i.e., model edges) to construct the basic network model. Of course, the embodiments of the present disclosure can also automatically execute the process from step S310 to step S312 through the modeling platform without manual participation of the modeling personnel.

The network modeling method provided by the embodiments of the present disclosure can collect the multi-dimensional instance information of the resources in the virtual network, where the multi-dimensional instance information of the resources includes the instance identifier of each resource and at least one entity attribute of each resource, the at least one entity attribute is at least one instance attribute other than the instance identifier in the instance information; thereby based on the instance identifier of each resource, the embodiments of the present disclosure can respectively abstract each resource into the node, and within the nodes abstracted from the resources, entities are abstracted based on the at least one entity attribute of each resource, where one entity attribute of each resource is abstracted into one entity in a node of each resource. Furthermore, relationships between different nodes can be determined based on the relationships between the associated entities. The abstracted nodes, the entities in the abstracted nodes, and the relationships between the abstracted nodes abstracted by the embodiments of the present disclosure can at least form the basic network model of the virtual network.

Through the embodiments of the present disclosure, the nodes in the basic network model are abstracted based on the instance identifier of each resource. There are the entities abstracted based on the at least one entity attribute of each resource in the abstracted nodes, and the relationships between different nodes are determined based on the relationships between the associated entities in different nodes. Therefore, in the basic network model, the nodes and the entities in the nodes are constructed on a per-resource basis, and the relationships between the associated entities in different nodes reflect relationships between the abstracted nodes. Through this method, the embodiments of the present disclosure can construct the nodes and the entities in the nodes on the per-resource basis and reflect relationships between the abstracted nodes through relationships between the associated entities in different nodes even when changes occur in the resource topology relationship of the virtual network, thus reflecting relationships between the resources. That is, the network modeling method provided by the embodiments of the present disclosure can be applied to situations where there are changes in the association relationships among the resources in the virtual network, so that even when there are changes in the relationships among the resources in the virtual network, it can still establish the basic network model of the virtual network relatively comprehensively and accurately, thereby fully and accurately reflecting the association relationships among the resources in the virtual network. It can be seen that the embodiments of the present disclosure can provide a standardized and accurate modeling solution for establishing the network model for the virtual network with changing resource relationships, improving the standardization and accuracy of the network model of the virtual network.

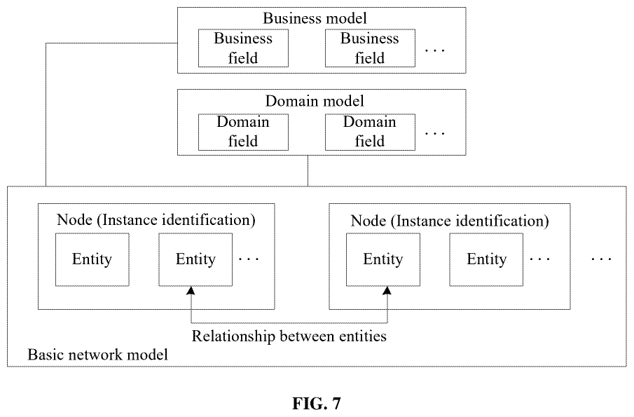

In some embodiments, the network model constructed for the virtual network in the embodiments of the present disclosure further includes a domain model. The domain model is a model built on the basis of the basic network model with domain fields and the domain fields reflect resource events related to various resources in the virtual network (such as alarm events, change events, etc. of the resources), thereby through associating the domain fields in the domain model with the nodes and/or the entities in the nodes in the basic network model, when the resource events occur in the virtual network, the nodes (corresponding to the resources) and the entities in the nodes (corresponding to instance attributes of the resources) related to the resource events can be determined. In some embodiments, FIG. 6A illustratively shows a flowchart of another network modeling method according to the embodiments of the present disclosure. The embodiments of the present disclosure execute the method flow shown in FIG. 6A to establish the domain model based on the method flow shown in FIG. 3 to establish the basic network model. As shown in FIG. 6A, the method flow includes the following steps.

In step S611, resource events related to the resources are determined in the virtual network and the resource events are set as domain fields.

In step S612, the domain fields are set as attributes of a domain model to construct the domain model, where the domain fields in the domain model are associated with nodes and/or entities in the nodes in a basic network model.

In the embodiments of the present disclosure, the domain model is created by adding the domain fields on the basis of the basic network model to reflect the resource events related to the resources in the virtual network through the domain fields. In some embodiments, the embodiments of the present disclosure determine the resource events (such as alarm events, change events, and other resource events) related to the resources in the virtual network, thereby setting one resource event as one domain field. Subsequently, the domain fields are set as attributes of the domain model to construct the domain model. That is, the domain model includes multiple domain fields, with one domain field reflecting one resource event in the virtual network.

In some embodiments, different domain fields in the domain model have association relationships, however the association relationships among the domain fields are not fixed. Based on specific domain fields in the domain model, the embodiments of the present disclosure can associate the domain fields with association relationships in the domain model based on expert experience.

After constructing the domain model, the domain fields in the domain model are associated with the nodes and/or the entities in the nodes in the basic network model, thereby when the resource events occur in the virtual network, resources associated with the resource events and instance attributes of the resources can be determined.

In some embodiments, the embodiments of the present disclosure edit the basic network model on the basis of a knowledge graph platform to add the domain fields from the domain model into the basic network model. For example, taking an operation and maintenance field as an example, technical personnel in the operation and maintenance field edit the basic network model on the knowledge graph platform, thereby adding the domain fields of the operation and maintenance field into the basic network model. In some examples, it is assumed that the basic network model sets a field a, a field b, and a field c for resources of virtual machines (for instance, the field a, the field b, and the field c are instance attributes of virtual machine resources, and correspondingly abstract entities of the field a, the field b, and the field c are in nodes of the virtual machines). Furthermore, it is assumed that domain-related fields for virtual machines are a field a, a field d, and a field e, through the field a, the domain-related field d and the domain-related field e for the virtual machines can be added to the virtual machines, thereby adding the domain fields on the basis of the basic network model.

In some embodiments, the network model constructed for the virtual network according to the embodiments of the present disclosure includes a business model. The business model is a model built on the basis of the basic network model with business fields. The business fields reflect business attributes corresponding to resources in the virtual network (such as instance business of the resources). In some embodiments, the business model is a specific business based on the domain model. For example, for a domain model of operation and maintenance, a business party adds business attributes. In some embodiments, FIG. 6B illustratively shows a flowchart of another network modeling method according to the embodiments of the present disclosure. The embodiments of the present disclosure execute the method flow shown in FIG. 6B to establish the business model based on the method flow shown in FIG. 3 to establish the basic network model, or based on the method flow shown in FIG. 6A to establish the domain model. As shown in FIG. 6B, the method flow includes the following steps.

In step S621, business attributes related to the resources are determined in the virtual network and the business attributes are set as business fields.

In step S622, the business fields are set as attributes of a business model to construct the business model, where the business fields in the business model are associated with nodes and/or entities in the nodes in the basic network model.

In some embodiments of the present disclosure, the business model is created by adding business fields on the basis of the basic network model to reflect business attributes related to the resources in the virtual network through the business fields. In some embodiments, the embodiments of the present disclosure determine business attributes (such as instance business, etc.) related to the resources in the virtual network, thereby setting one business attribute as one business field. Subsequently, the business fields are set as attributes of the business model to construct the business model. That is, the business model includes multiple business fields, with one business field reflecting one business attribute of resources in the virtual network.

In some embodiments, different business fields in the business model have association relationships, however the association relationships among business fields are not fixed. Based on specific business fields in the business model, the embodiments of the present disclosure can associate the business fields with association relationships in the business model based on expert experience. It should be noted that when setting association relationships for the domain fields in the domain model, the embodiments of the present disclosure can be implemented based on domain expert experience, and when setting association relationships for the business fields in the business model, the embodiments of the present disclosure can be implemented based on business expert experience.

After constructing the business model, the business fields in the business model are associated with the nodes and/or the entities in the nodes in the basic network model, thereby reflecting specific business attributes related to the nodes and the entities in the nodes in the basic network model. In some embodiments, the embodiments of the present disclosure can edit the basic network model on the basis of a knowledge graph platform to add the business fields from the business model into the basic network model.

It should be noted that the business model expresses business concepts of resources and relationships between the resources, while the domain model refines and abstracts the resources at the level of resource events. In some embodiments, the business fields in the business model can be customized by a business provider, and the embodiments of the present disclosure do not limit this.

In some embodiments for constructing the network model for the virtual network, the embodiments of the present disclosure can abstract the resources of the virtual network such as virtual network resources, physical resources, cloud network elements, physical forwarding devices, etc., into the abstracted nodes, which are identified by the instance ID of each resource. The instance models, the instance regions, and other instance attributes of the resources are abstracted into the entities in the nodes, thereby setting relationships between the associated entities in different nodes as relationships between different nodes to construct the basic network model of the virtual network.

In some embodiments, resource events (such as alarm events, change events, etc.) related to virtual network resources, physical resources, cloud network elements, physical forwarding devices, etc., form domain fields and serve as attributes of the domain model to construct the domain model. The domain fields in the domain model are combined with the nodes and/or the entities in the nodes in the basic network model (for example, adding the domain fields on the basis of the nodes and/or the entities in the nodes in the basic network model) to identify resources and instance attributes of the resources related to the resource events.

In some embodiments, business attributes of virtual network resources, physical resources, cloud network elements, physical forwarding devices, etc., form business fields and serve as attributes of the business model to construct the business model. The business fields in the business model can be combined with nodes and/or the entities in the nodes (for example, adding business fields on the basis of in the basic network model) to identify businesses corresponding to resources and instance attributes of the resources.

For ease of understanding, FIG. 7 illustratively shows an example diagram of a network model of a virtual network according to some embodiments of the present disclosure. As shown in FIG. 7, the network model of the virtual network is divided into three layers: a basic network model, a domain model, and a business model. The basic network model includes multiple nodes, multiple entities in each node, and relationships between the abstracted nodes. The nodes are abstracted from resources in the virtual network and identified by an instance identifier of each resource. The entities in the nodes are abstracted from instance attributes of the resources except the instance identifier. The relationships between different nodes are expressed through relationships between associated entities in different nodes. The domain model includes multiple domain fields to reflect resource events related to the resources in the virtual network. The domain fields in the domain model are added on the basis of the nodes and/or the entities in the nodes in the basic network model. The business model includes multiple business fields to reflect business attributes related to the resources in the virtual network. The business fields in the business model are added on the basis of the nodes and/or the entities in the nodes in the basic network model.

The network modeling method provided by the embodiments of the present disclosure can use a modeling platform to process multi-dimensional resource data of the virtual network to build a standardized network model for the virtual network, including the basic network model, the domain model, and the business model, so at to solve problems like complex topology relationships and changing relationships in Overlay and other virtual networks, thereby establishing the standardized network model for the virtual network, and enhancing the standardization degree and accuracy of the network model of the virtual network.

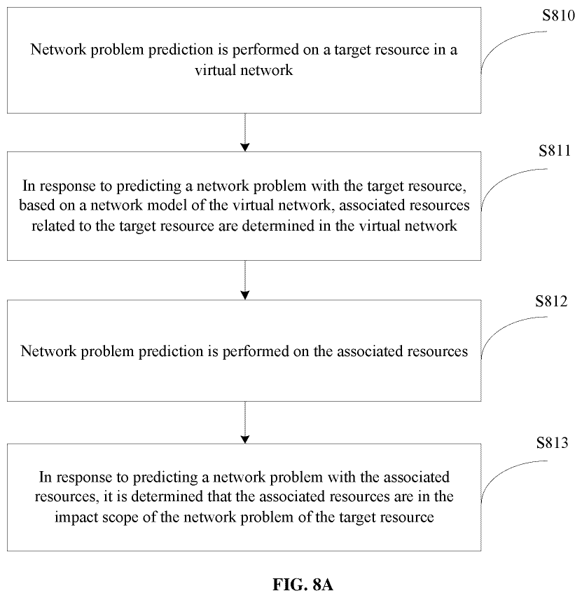

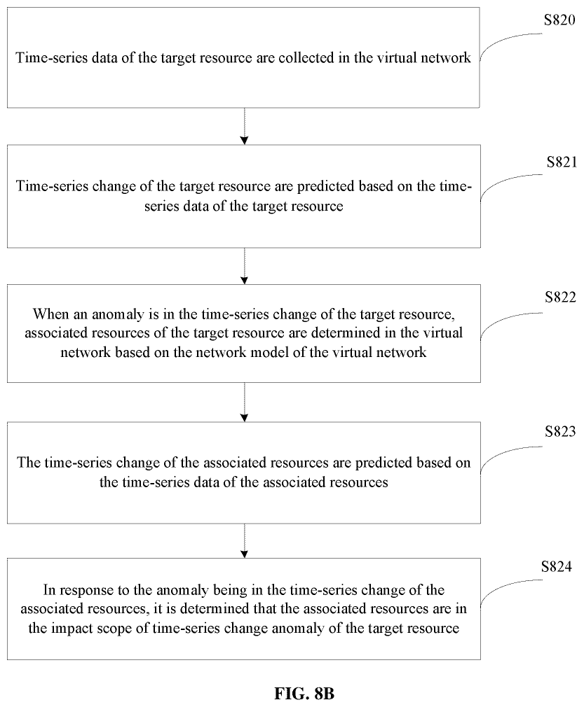

After constructing the network model for the virtual network, the embodiments of the present disclosure can utilize the network model to conduct impact analysis on the network problem in the virtual network. In some embodiments, FIG. 8A illustratively shows a flowchart of a network problem analysis method according to some embodiments of the present disclosure. The method flow is executed by a cloud server. As shown in FIG. 8A, the method flow includes the following steps.

In step S810, network problem prediction is performed on a target resource in a virtual network.

The target resource is any resource or a designated resource in the virtual network. The specific form of the target resource is not defined by the embodiments of the present disclosure. For the target resource in the virtual network, the embodiments of the present disclosure can predict the network problem for the target resource, so that when the network problem is predicted for the target resource, through the network model of the virtual network, other resources associated with the target resource at the network topology level (referred to as associated resources) can be identified, thereby predicting whether these associated resources will encounter the network problem to determine whether the associated resources are in the impact scope of the network problem of the target resource. That is, when the network problem is predicted for the target resource and the associated resources of the target resource at the network topology level further encounter the network problem, the associated resources are considered to be in the impact scope of the network problem of the target resource.

In some embodiments, the embodiments of the present disclosure can achieve network problem prediction for the target resource through predicting whether an anomaly is in time-series change of the target resource. The anomaly in the time-series change of the target resource can be seen as one form of the network problem occurring for the target resource. In some embodiments, the embodiments of the present disclosure can collect time-series data of the target resource in the virtual network. The time-series change of the target resource are predicted based on the time-series data of the target resource, thereby determining whether the anomaly is in time-series change of the target resource to perform network problem prediction for the target resource.

In some embodiments, to more accurately predict time-series change of the target resource, the embodiments of the present disclosure combine multi-dimensional instance information of the target resource with the time-series data of the target resource, so that the time-series data of the target resource carries a multi-dimensional instance information label of the target resource. For example, the multi-dimensional instance information of the target resource is set as a label attribute, which is carried in the time-series data of the target resource, thereby using the target resource carrying time-series data of multi-dimensional instance information to predict time-series change of the target resource, so as to more accurately predict time-series change of the target resource while taking into account both the time-series data of the target resource and the multi-dimensional instance attributes of the target resource.

In step S811, in response to predicting a network problem with the target resource, based on a network model of the virtual network, associated resources related to the target resource are determined in the virtual network.

When predicting that the target resource encounters the network problem (for example, the anomaly is in the time-series change of the target resource), the embodiments of the present disclosure can utilize the network model of the virtual network to determine the associated resources of the target resource in the virtual network. Subsequently, through predicting whether the associated resources encounter the network problem, it is determined whether the associated resources are in the impact scope of the network problem of the target resource. Based on the network modeling method provided by the embodiments of the present disclosure, the embodiments of the present disclosure can abstract resources into nodes, and abstract entity attributes of the resources into entities in the abstracted nodes, set relationships between the associated entities among different nodes as relationships between the abstracted nodes. Therefore, the network model constructed based on the network modeling method provided by the embodiments of the present disclosure can reflect topological relationships between the resources in the virtual network. Thus, based on the topological relationships between the resources reflected by the network model, when the target resource encounters the network problem, the embodiments of the present disclosure can determine the associated resources that have topological associations with the target resource. The resources with topological associations are seen as resources connected through model edges, and model edges are expressed through relationships between the associated entities among the nodes.

In some examples, based on relationships among the nodes reflected by the network model, the embodiments of the present disclosure can determine associated nodes of the node of the target resource, resources corresponding to the associated nodes are set as the associated resources. In some examples, when the physical machine encounters the network problem, the embodiments of the present disclosure can determine the associated nodes having topological associations with the node of the physical machine based on the constructed network model (for instance, virtual machines associated with the physical machine) to identify the associated resources corresponding to the resources in the form of the physical machine. When the virtual machine encounters the network problem, the embodiments of the present disclosure can determine the associated nodes having topological associations with the node of the virtual machine based on the constructed network model (for instance, other virtual machines communicating with the virtual machine, other virtual machines residing on the same physical machine as the virtual machine, etc.) to identify the associated resources of the resources in the form of the virtual machine.

In step S812, network problem prediction is performed on the associated resources.

After identifying the associated resources of the target resource, the embodiments of the present disclosure can perform network problem prediction for the associated resources. In some embodiments, the means for performing network problem prediction on the associated resources is the same as the means for performing network problem prediction on the target resource. The embodiments of the present disclosure can collect time-series data of the associated resources in the virtual network. Based on the time-series data of the associated resources, the time-series change of the associated resources are predicted, thereby determining whether the anomaly is in the time-series change of the associated resources to perform network problem prediction on the associated resources. In some embodiments, the embodiments of the present disclosure can predict the time-series change of the associated resources through combining multi-dimensional instance information of the associated resources with time-series data of the associated resources.

In step S813, in response to predicting a network problem with the associated resources, it is determined that the associated resources are in the impact scope of the network problem of the target resource.

When predicting that the associated resources encounter the network problem (for example, the anomaly is in the time-series change of associated resources), it can be considered that the target resource has encountered the network problem, which further affects the associated resources to encounter the network problem (i.e., the network problem of the associated resources arise due to the influence of the network problem of the target resource), thus determining that the associated resources are in the impact scope of the network problem of the target resource, i.e., determining that the associated resources are in the impact scope of the network problem of the target resource.

The network problem analysis method provided by the embodiments of the present disclosure, when predicting that the target resource in the virtual network encounters the network problem, the associated resources of the target resource at the network topology level of the virtual network are determined based on the network model (at least including the basic network model) of the virtual network constructed according to the embodiments of the present disclosure, thereby through predicting whether the associated resources further encounter the network problem, determining whether the associated resources are in the impact scope of the network problem of the target resource, so as to achieve impact scope analysis when the network problem occurs in resources of the virtual network. The network problem analysis method provided by the embodiments of the present disclosure can determine other associated resources affected by resources based on the network model of the virtual network constructed according to the embodiments of the present disclosure, thereby accurately analyzing other resources in the impact scope of the network problem of the resources when the network problem occurs, accurately analyzing and determining the impact scope of the network problem in the virtual network, improving the accuracy of the impact scope analysis result.

In some embodiments, the embodiments of the present disclosure can perform network problem prediction on resources through predicting and analyzing time-series data of the resources. In some embodiments, FIG. 8B illustratively shows a flowchart of another network problem analysis method according to some embodiments of the present disclosure. As shown in FIG. 8B, the method flow includes the following steps.

In step S820, time-series data of the target resource are collected in the virtual network.

In some embodiments, the time-series data of the resources is understood as metric data of the resources changing over time, for example, metric data such as CPU utilization and traffic of resources changing over time.

It should be noted that multi-dimensional instance information of the resources in the virtual network, serving as the multi-dimensional resource data of the resources, is essentially spatiotemporal data of the resources and does not possess time-series attributes. Whereas time-series data of the resources expresses metric data of the resources under temporal changes and the time-series data of the resources has time-series attributes. In some embodiments, databases used by the embodiments of the present disclosure for collecting multi-dimensional instance information and time-series data of the resources can be different. For example, the embodiments of the present disclosure can collect multi-dimensional instance information of the resources in the virtual network from the database such as a relational database (mysql), a configuration management database (cmdb), etc.; and collect time-series data of the resources in the virtual network from the database such as kafka, etc.

In step S821, time-series change of the target resource are predicted based on the time-series data of the target resource.

In some embodiments, the embodiments of the present disclosure use a Long Short Term Memory (LSTM) model to fit the time-series data of the target resource, so as to predict the time-series change of the target resource (for example, changes in network traffic of the target resource, etc.).

In some embodiments, the embodiments of the present disclosure combine time-series data of the target resource with multi-dimensional instance information of the target resource, so that the time-series data of the target resource carries the multi-dimensional instance information, for example, setting the multi-dimensional instance information of the target resource as the multi-dimensional label attribute, which is carried in the time-series data of the target resource. The embodiments of the present disclosure can use an LSTM model to fit the time-series data of the target resource carrying the multi-dimensional instance information, so as to consider the multi-dimensional instance attribute of the target resource when fitting the time-series data of the target resource, making the predicted time-series change of the target resource more accurate.

In some embodiments, the embodiments of the present disclosure can combine the time-series data of the target resource with the multi-dimensional instance information of the target resource based on identification information of the target resource. For example, the time-series data of the target resource carries identification information of the target resource (such as the instance ID of the target resource), and the multi-dimensional instance information of the target resource further carries the identification information of the target resource, thus the embodiments of the present disclosure can combine the time-series data and the multi-dimensional instance information belonging to the same target resource through the identification information of the target resource. For example, on the basis of collecting the time-series data and the multi-dimensional instance information from different databases, the embodiments of the present disclosure can combine the time-series data and the multi-dimensional instance information belonging to the same resource through the identification information of the same resource in the time-series data and the multi-dimensional instance information.

After combining the time-series data and the multi-dimensional instance information of the target resource, the time-series data of the target resource can possess the multi-dimensional label attribute of the instance information. Based on the time-series data carrying the multi-dimensional label attribute, the embodiments of the present disclosure use the LSTM model for data fitting to predict the time-series change of the target resource.

In step S822, when an anomaly is in the time-series change of the target resource, associated resources of the target resource are determined in the virtual network based on the network model of the virtual network.

The anomaly in the time-series change of the target resource is exemplified by a decline or fluctuation in the time-series data of the target resource. In some examples, taking the time-series data as the network traffic, based on network traffic changes of the target resource (one example of time-series change of the target resource), when the network traffic of the target resource experiences the decline or fluctuation, it is considered that the anomaly is in the network traffic changes of the target resource.

In step S823, the time-series change of the associated resources are predicted based on the time-series data of the associated resources.

In some embodiments, the means for predicting the time-series change of the association resources can be analogously referred to the means for predicting the time-series change of the target resource, and thus will not be elaborated here.

In step S824, in response to the anomaly being in the time-series change of the associated resources, it is determined that the associated resources are in the impact scope of time-series change anomaly of the target resource.

In response to the anomaly being in the time-series change of the associated resources, the embodiments of the present disclosure deem that under the influence of the time-series change anomaly of the target resource, the association resources further experience the network problem of the time-series change anomaly. Therefore, the associated resources are in the impact scope of time-series change anomaly of the target resource.

To facilitate understanding of the network modeling method and the network problem analysis method provided by the embodiments of the present disclosure, FIG. 9 exemplarily shows a system architecture diagram according to the embodiments of the present disclosure. As shown in FIG. 9, the cloud server includes a modeling platform 910, a data management platform 920, and a data analysis engine 930. The modeling platform is arranged for constructing a network model for a virtual network. The data management platform and the data analysis engine are arranged for analyzing the impact scope of the network problem in the virtual network.

In some embodiments, the modeling platform constructs the basic network model based on the multi-dimensional instance information of the resources in the virtual network. The domain model and the business model are constructed on the basis of the basic network model.

In some embodiments, the data management platform combines the time-series data of the resources in the virtual network with the multi-dimensional instance information to obtain the time-series data of the resources carrying the multi-dimensional instance information.

In some embodiments, the data analysis engine predicts the time-series change of the resources based on the time-series data of the resources carrying the multi-dimensional instance information. And the data analysis engine determines the association resources topologically linked to the resources based on the network model constructed by the modeling platform. When predicting that the anomaly is in the time-series change of a certain resource and the anomaly is further in the time-series change of the association resources of the certain resource, it is deemed that the association resources are in the impact scope of the time-series change anomaly of the certain resource.

In some embodiments, in a system architecture of the cloud server provided by the embodiments of the present disclosure, the modeling platform is arranged for executing the network modeling method as mentioned in the method embodiments of the present disclosure. The data management platform is arranged for combining time-series data and multi-dimensional instance information of the target resource in a virtual network to obtain the time-series data of the target resource carrying the multi-dimensional instance information; and combining time-series data and multi-dimensional instance information of associated resources in the virtual network to obtain the time-series data of the associated resources carrying the multi-dimensional instance information. The data analysis engine is arranged for predicting time-series change of the target resource based on the time-series data of the target resource carrying the multi-dimensional instance information, in response to an anomaly being in the time-series change of the target resource, determining the associated resources having a topological association with the target resource based on the network model constructed by the modeling platform and predicting time-series change of the associated resources based on the time-series data of the associated resources carrying the multi-dimensional instance information, and in response to an anomaly being in the time-series change of the associated resources, determining that the associated resources are in the impact scope of time-series change anomaly of the target resource.

The network problem analysis method provided by the embodiments of the present disclosure determines the association resources of the target resource based on the network model of the virtual network. Subsequently, when the network problem occurs in the target resource, whether the network problem occurs in the association resources of the target resource is predicted to accurately determine the impact scope of the network problem, thereby alleviating pressure on maintenance personnel for the virtual network.

The following introduces the network modeling apparatus provided by embodiments of the present disclosure. The apparatus content described below may be considered as functional modules that need to be set up in the cloud server for implementing the network modeling method provided by embodiments of the present disclosure. The apparatus content described below can be cross-referenced with the content described above.

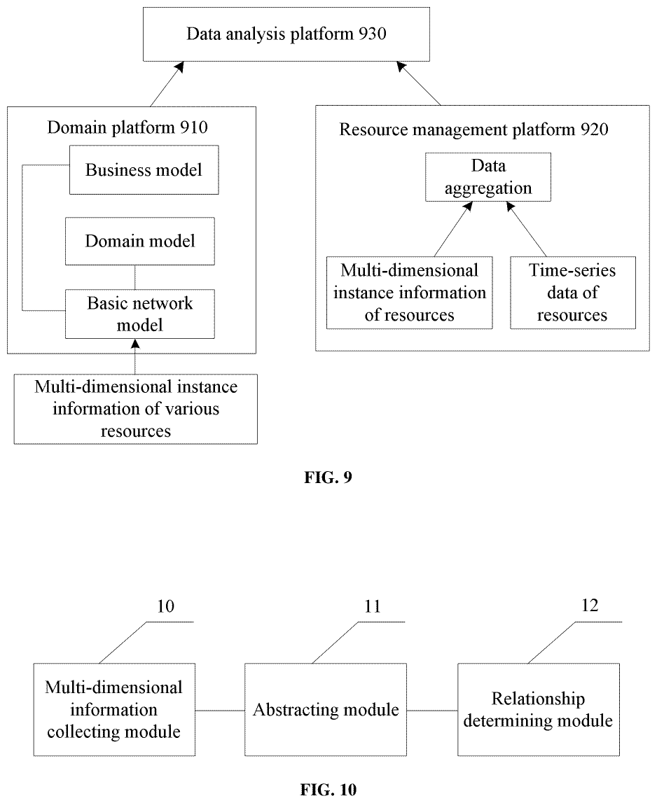

In some embodiments, FIG. 10 is a block diagram of a network modeling apparatus according to some embodiments of the present disclosure. As shown in FIG. 10, the apparatus includes: a multi-dimensional information collecting module 10, arranged for collecting multi-dimensional instance information of various resources in a virtual network, where the multi-dimensional instance information of the resources includes an instance identifier of each resource and at least one entity attribute of each resource, and the at least one entity attribute is an instance attribute other than the instance identifier in the multi-dimensional instance information; an abstracting module 11, arranged for abstracting each resource into a node based on the instance identifier of each resource; and, within the nodes abstracted from the resources, abstracting entities based on the at least one entity attribute of each resource, where one entity attribute of each resource is abstracted into one entity in a node of each resource; and a relationship determining module 12, arranged for determining relationships between different nodes based on relationships between associated entities, where the abstracted nodes, entities in the abstracted nodes, and relationships between the abstracted nodes collectively form at least one basic network model of the virtual network.

In some embodiments, the abstracting module 11 is arranged for abstracting each resource into the node based on the instance identifier of each resource includes: abstracting each resource into the node, and extracting the instance identifier of each resource as metadata, which is stored in the node of each resource.

In some embodiments, the relationship determining module 12 is arranged for determining the relationships between different nodes based on the relationships between the associated entities includes: setting the relationships between the associated entities in different nodes as the relationships between different nodes, where the associated entities in different nodes include entities of the same type in different nodes, or different types of entities having an association relationship specified in different nodes; the entities of the same type are abstracted based on the same type of entity attributes, and entities of different types are abstracted based on different types of entity attributes.

In some embodiments, the multi-dimensional information collecting module 10 is arranged for collecting the multi-dimensional instance information of the resources in the virtual network includes: collecting multi-dimensional instance information of various virtual resources and multi-dimensional instance information of various physical resources in the virtual network, where the various virtual resources are obtained based on the virtualization of the various physical resources.

In some embodiments, the apparatus is further arranged for determining resource events related to the resources in the virtual network and setting the resource events as domain fields; and setting the domain fields as attributes of a domain model to construct the domain model, where the domain fields in the domain model are associated with nodes and/or entities in the nodes in a basic network model; and/or
determining business attributes related to the resources in the virtual network and setting the business attributes as business fields; setting the business fields as attributes of a business model to construct the business model, where the business fields in the business model are associated with nodes and/or entities in the nodes in the basic network model.

In some embodiments, an operation of associating the domain fields in the domain model with the nodes and/or the entities in the nodes in the basic network model includes the following steps. The domain fields are added in the domain model on the basis of the nodes and/or the entities in the nodes in the basic network model

In some embodiments, an operation of associating the business fields in the business model with the nodes and/or the entities in the nodes in the basic network model includes the following steps. The business fields are added in the business model on the basis of the nodes and/or the entities in the nodes in the basic network model.

The following introduces the network problem analysis apparatus provided by the embodiments of the present disclosure. The apparatus content described below is considered as functional modules required to be set up in the cloud server for implementing the network problem analysis method provided by the embodiments of the present disclosure. The apparatus content described below can be cross-referenced with the content described above.

In some embodiments, FIG. 11 is a block diagram of a network problem analysis apparatus according to some embodiments of the present disclosure. As shown in FIG. 11, the apparatus includes: a first predicting module 20, arranged for performing network problem prediction on a target resource in a virtual network; an associated resources determining module 21, arranged for in response to predicting a network problem with the target resource, based on a network model of the virtual network, determining associated resources related to the target resource in the virtual network; a second predicting module 22, arranged for performing network problem prediction on the associated resources; and an impact scope determining module 23, arranged for in response to predicting a network problem with the associated resources, determining that the associated resources are in the impact scope of the network problem of the target resource.

In some embodiments, the first predicting module 20 is arranged for performing network problem prediction on the target resource in the virtual network includes: collecting time-series data of the target resource in the virtual network; and predicting time-series change of the target resource based on the time-series data of the target resource, where in response to an anomaly being in the time-series change of the target resource, it is predicted that the target resource have the network problem.

In some embodiments, the second predicting module 22 is arranged for performing the network problem prediction on the associated resources includes: predicting the time-series change of the target resource.

In some embodiments, the impact scope determining module 23 is arranged for in response to predicting the network problem with the associated resources, determining that the associated resources are in the impact scope of the network problem of the target resource includes: in response to the anomaly being in the time-series change of the associated resources, determining that the associated resources are in the impact scope of time-series change anomaly of the target resource.

In some embodiments, the first predicting module 20 is arranged for predicting the time-series change of the target resource based on the time-series data of the target resource includes: combining the time-series data of the target resource with the multi-dimensional instance information of the target resource to obtain the time-series data of the target resource carrying the multi-dimensional instance information; and fitting the time-series data of the target resource carrying the multi-dimensional instance information to predict the time-series change of the target resource.

In some embodiments, the time-series change include changes in network traffic; an anomaly in the time-series change includes a decline or fluctuation in network traffic.

In some embodiments, the associated resources determining module 21 is arranged for determining the associated resources related to the target resource in the virtual network based on the network model of the virtual network includes: based on topological relationships between resources reflected by the network model, determining the associated resources having a topological association with the target resource; where the network model includes a basic network model, the basic network model includes nodes, entities in the abstracted nodes, and relationships between the abstracted nodes, the nodes are abstracted from resources in the virtual network, the entities in the nodes are abstracted from entity attributes of the resources, and relationships between the abstracted nodes are determined based on relationships between associated entities of the nodes.

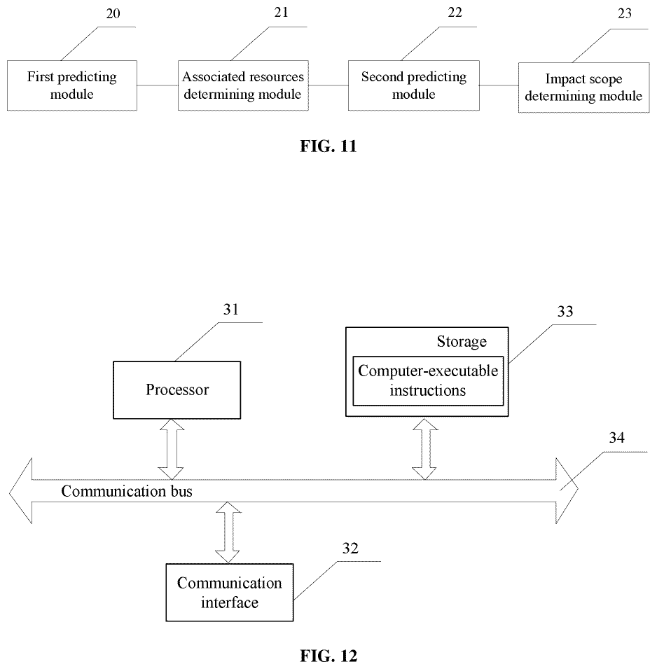

The embodiments of the present disclosure further provide a cloud server. The cloud server implements the network modeling method provided by the embodiments of the present disclosure through setting the aforementioned network modeling apparatus, and implements the network problem analysis method provided by the embodiments of the present disclosure through setting the aforementioned network problem analysis apparatus. In a hardware architecture, FIG. 12 shows a block diagram of a cloud server according to some embodiments of the present disclosure. As shown in FIG. 12, the cloud server includes: at least one processor 31, at least one communication interface 32, at least one memory 33, and at least one communication bus 34.

In some embodiments of the present disclosure, the number of the processor 31, the communication interface 32, the memory 33, and the communication bus 34 is at least one, and the processor 31, the communication interface 32, and the memory 33 communicate with each other through the communication bus 34.

In some embodiments, the communication interface 32 is an interface for a communication module used for network communication.

In some embodiments, the processor 31 is a Central Processing Unit (CPU), a Graphics Processing Unit (GPU), an embedded neural network processor (NPU), a Field Programmable Gate Array (FPGA), a Tensor Processing Unit (TPU), an Artificial Intelligence (AI) chip, Application Specific Integrated Circuit (ASIC), or at least one integrated circuit arranged for implementing the embodiments of the present disclosure.

The memory 33 contains a high-speed RAM memory and may further include a non-transitory memory, such as at least one disk storage device.

The memory 33 stores at least one computer-executable instruction, and the processor 31 invokes the at least one computer-executable instruction to execute the network modeling method provided by the embodiments of the present disclosure, or the network problem analysis method provided by the embodiments of the present disclosure.

The embodiments of the present disclosure further provide a storage medium. The storage medium stores at least one computer-executable instruction, and the at least one computer-executable instruction is executed to implement the network modeling method provided by the embodiments of the present disclosure, or the network problem analysis method provided by the embodiments of the present disclosure.

The embodiments of the present disclosure further provide a computer program. The computer program is executed to implement the network modeling method provided by the embodiments of the present disclosure, or the network problem analysis method provided by the embodiments of the present disclosure.

The network modeling method provided by the embodiments of the present disclosure can collect the multi-dimensional instance information of the resources in the virtual network, where the multi-dimensional instance information of the resources includes the instance identifier of each resource and at least one entity attribute of each resource, the at least one entity attribute is at least one instance attribute other than the instance identifier in the instance information; thereby based on the instance identifier of each resource, the embodiments of the present disclosure can respectively abstract each resource into the node, and within the nodes abstracted from the resources, entities are abstracted based on the at least one entity attribute of each resource, where one entity attribute of each resource is abstracted into one entity in a node of each resource. Furthermore, relationships between different nodes can be determined based on the relationships between the associated entities. The abstracted nodes, the entities in the abstracted nodes, and the relationships between the abstracted nodes abstracted by the embodiments of the present disclosure can at least form the basic network model of the virtual network.

Through the embodiments of the present disclosure, the nodes in the basic network model are abstracted based on the instance identifier of each resource. There are the entities abstracted based on the at least one entity attribute of each resource in the abstracted nodes, and the relationships between different nodes are determined based on the relationships between the associated entities in different nodes. Therefore, in the basic network model, the nodes and the entities in the nodes are constructed on a per-resource basis, and the relationships between the associated entities in different nodes reflect relationships between the abstracted nodes. Through this method, the embodiments of the present disclosure can construct the nodes and the entities in the nodes on the per-resource basis and reflect relationships between the abstracted nodes through relationships between the associated entities in different nodes even when changes occur in the resource topology relationship of the virtual network, thus reflecting relationships between the resources. That is, the network modeling method provided by the embodiments of the present disclosure can be applied to situations where there are changes in the association relationships among the resources in the virtual network, so that even when there are changes in the relationships among the resources in the virtual network, it can still establish the basic network model of the virtual network relatively comprehensively and accurately, thereby fully and accurately reflecting the association relationships among the resources in the virtual network. It can be seen that the embodiments of the present disclosure can provide a standardized and accurate modeling solution for establishing the network model for the virtual network with changing resource relationships, improving the standardization and accuracy of the network model of the virtual network.

Above describes multiple implementation solutions provided by the embodiments of the present disclosure, and the various exemplary methods introduced in each implementation solution can be combined and cross-referenced without conflict, thereby extending to numerous possible implementation solutions, all of which can be considered disclosed and publicized implementation solutions of the present disclosure. Although the present disclosure has been disclosed as above, it is not limited thereto. A person having ordinary skill in the art, without departing from the spirit and scope of the present disclosure, can make various modifications and changes, therefore the protection scope of the present disclosure should be subject to the scope defined by the claims.

1. A network modeling method, comprising:
collecting multi-dimensional instance information of various resources in a virtual network, wherein the multi-dimensional instance information of the resources comprises an instance identifier of each resource and at least one entity attribute of each resource, and the at least one entity attribute is an instance attribute other than the instance identifier in the multi-dimensional instance information;
abstracting each resource into a node based on the instance identifier of each resource; and, within the nodes abstracted from the resources, abstracting entities based on the at least one entity attribute of each resource, wherein one entity attribute of each resource is abstracted into one entity in a node of each resource; and
determining relationships between different nodes based on relationships between associated entities;
wherein the abstracted nodes, entities in the abstracted nodes, and relationships between the abstracted nodes collectively form at least one basic network model of the virtual network.

2. The method according to claim 1, wherein abstracting each resource into the node based on the instance identifier of each resource comprises:
abstracting each resource into the node, and extracting the instance identifier of each resource as metadata, which is stored in the node of each resource.

3. The method according to claim 1, wherein determining the relationships between different nodes based on the relationships between the associated entities comprises:
setting the relationships between the associated entities in different nodes as the relationships between different nodes;
wherein the associated entities in different nodes comprise: entities of the same type in different nodes, or different types of entities having an association relationship specified in different nodes;
the entities of the same type are abstracted based on the same type of entity attributes, and entities of different types are abstracted based on different types of entity attributes.

4. The method according to claim 1, wherein collecting the multi-dimensional instance information of the resources in the virtual network comprises:
collecting multi-dimensional instance information of various virtual resources and multi-dimensional instance information of various physical resources in the virtual network;
wherein the various virtual resources are obtained based on the virtualization of the various physical resources.

5. The method according to claim 1, further comprising at least of one of the following:
determining resource events related to the resources in the virtual network and setting the resource events as domain fields; and setting the domain fields as attributes of a domain model to construct the domain model, wherein the domain fields in the domain model are associated with nodes and/or entities in the nodes in a basic network model; and
determining business attributes related to the resources in the virtual network and setting the business attributes as business fields; setting the business fields as attributes of a business model to construct the business model, wherein the business fields in the business model are associated with nodes and/or entities in the nodes in the basic network model.

6. The method according to claim 5, wherein associating the domain fields in the domain model with the nodes and/or the entities in the nodes in the basic network model comprises:
adding the domain fields in the domain model on the basis of the nodes and/or the entities in the nodes in the basic network model; and
associating the business fields in the business model with the nodes and/or the entities in the nodes in the basic network model comprises:
adding the business fields in the business model on the basis of the nodes and/or the entities in the nodes in the basic network model.

7. A network problem analysis method, comprising:
performing network problem prediction on a target resource in a virtual network;
in response to predicting a network problem with the target resource, based on a network model of the virtual network, determining associated resources related to the target resource in the virtual network;
performing network problem prediction on the associated resources; and
in response to predicting a network problem with the associated resources, determining that the associated resources are in the impact scope of the network problem of the target resource.

8. The method according to claim 7, wherein performing network problem prediction on the target resource in the virtual network comprises:
collecting time-series data of the target resource in the virtual network; and
predicting time-series change of the target resource based on the time-series data of the target resource, wherein in response to an anomaly being in the time-series change of the target resource, it is predicted that the target resource have the network problem.

9. The method according to claim 8, wherein performing the network problem prediction on the associated resources comprises:
predicting the time-series change of the target resource; and
in response to predicting the network problem with the associated resources, determining that the associated resources are in the impact scope of the network problem of the target resource comprises:
in response to the anomaly being in the time-series change of the associated resources, determining that the associated resources are in the impact scope of time-series change anomaly of the target resource.

10. The method according to claim 8, wherein predicting the time-series change of the target resource based on the time-series data of the target resource comprises:
combining the time-series data of the target resource with the multi-dimensional instance information of the target resource to obtain the time-series data of the target resource carrying the multi-dimensional instance information; and
fitting the time-series data of the target resource carrying the multi-dimensional instance information to predict the time-series change of the target resource.

11. The method according to claim 8, wherein the time-series change comprise changes in network traffic; an anomaly in the time-series change comprises a decline or fluctuation in network traffic.

12. The method according to claim 7, wherein determining the associated resources related to the target resource in the virtual network based on the network model of the virtual network comprises:
based on topological relationships between resources reflected by the network model, determining the associated resources having a topological association with the target resource;
wherein the network model comprises a basic network model, the basic network model comprises nodes, entities in the abstracted nodes, and relationships between the abstracted nodes, the nodes are abstracted from resources in the virtual network, the entities in the nodes are abstracted from entity attributes of the resources, and relationships between the abstracted nodes are determined based on relationships between associated entities of the nodes.

13. A cloud server, comprising:
a modeling platform, arranged for collecting multi-dimensional instance information of various resources in a virtual network, wherein the multi-dimensional instance information of the resources comprises an instance identifier of each resource and at least one entity attribute of each resource, and the at least one entity attribute is an instance attribute other than the instance identifier in the multi-dimensional instance information; abstracting each resource into a node based on the instance identifier of each resource; and, within the nodes abstracted from the resources, abstracting entities based on the at least one entity attribute of each resource, wherein one entity attribute of each resource is abstracted into one entity in a node of each resource; and determining relationships between different nodes based on relationships between associated entities, wherein the abstracted nodes, entities in the abstracted nodes, and relationships between the abstracted nodes collectively form at least one basic network model of the virtual network;
a data management platform, arranged for combining time-series data and multi-dimensional instance information of a target resource in a virtual network to obtain the time-series data of the target resource carrying the multi-dimensional instance information; and combining time-series data and multi-dimensional instance information of associated resources in the virtual network to obtain the time-series data of the associated resources carrying the multi-dimensional instance information;
a data analysis engine, arranged for predicting time-series change of the target resource based on the time-series data of the target resource carrying the multi-dimensional instance information, in response to an anomaly being in the time-series change of the target resource, determining the associated resources having a topological association with the target resource based on the network model constructed by the modeling platform and predicting time-series change of the associated resources based on the time-series data of the associated resources carrying the multi-dimensional instance information, and in response to an anomaly being in the time-series change of the associated resources, determining that the associated resources are in the impact scope of time-series change anomaly of the target resource.

14. (canceled)

15. (canceled)

16. The method according to claim 2, further comprising at least of one of the following:
determining resource events related to the resources in the virtual network and setting the resource events as domain fields; and setting the domain fields as attributes of a domain model to construct the domain model, wherein the domain fields in the domain model are associated with nodes and/or entities in the nodes in a basic network model; and
determining business attributes related to the resources in the virtual network and setting the business attributes as business fields; setting the business fields as attributes of a business model to construct the business model, wherein the business fields in the business model are associated with nodes and/or entities in the nodes in the basic network model.

17. The method according to claim 3, further comprising at least of one of the following:
determining resource events related to the resources in the virtual network and setting the resource events as domain fields; and setting the domain fields as attributes of a domain model to construct the domain model, wherein the domain fields in the domain model are associated with nodes and/or entities in the nodes in a basic network model; and
determining business attributes related to the resources in the virtual network and setting the business attributes as business fields; setting the business fields as attributes of a business model to construct the business model, wherein the business fields in the business model are associated with nodes and/or entities in the nodes in the basic network model.

18. The method according to claim 4, further comprising at least of one of the following:
determining resource events related to the resources in the virtual network and setting the resource events as domain fields; and setting the domain fields as attributes of a domain model to construct the domain model, wherein the domain fields in the domain model are associated with nodes and/or entities in the nodes in a basic network model; and
determining business attributes related to the resources in the virtual network and setting the business attributes as business fields; setting the business fields as attributes of a business model to construct the business model, wherein the business fields in the business model are associated with nodes and/or entities in the nodes in the basic network model.

19. The method according to claim 9, wherein the time-series change comprise changes in network traffic; an anomaly in the time-series change comprises a decline or fluctuation in network traffic.

20. The cloud server according to claim 13, wherein the modeling platform is arranged for abstracting each resource into the node, and extracting the instance identifier of each resource as metadata, which is stored in the node of each resource.

21. The cloud server according to claim 13, wherein the modeling platform is arranged for setting the relationships between the associated entities in different nodes as the relationships between different nodes, wherein the associated entities in different nodes comprise: entities of the same type in different nodes, or different types of entities having an association relationship specified in different nodes; the entities of the same type are abstracted based on the same type of entity attributes, and entities of different types are abstracted based on different types of entity attributes.

22. The cloud server according to claim 13, wherein the modeling platform is arranged for collecting multi-dimensional instance information of various virtual resources and multi-dimensional instance information of various physical resources in the virtual network, wherein the various virtual resources are obtained based on the virtualization of the various physical resources.
